(19) United States
(12) Patent Application Publication
(10) Pub. No.: US 2025/0159768 A1
(43) Pub. Date: May 15, 2025

(54) HEATING COIL FOR HIGH-FREQUENCY HEATER

(71) Applicant: TKE Co.,Ltd, Yatomi-shi, Aichi (JP)

(72) Inventors: Hideaki ITO, Yatomi-shi, Aichi (JP); Kazuhiro ABE, Yatomi-shi, Aichi (JP)

(21) Appl. No.: 18/839,387

(22) PCT Filed: Mar. 30, 2022
(86) PCT No.: PCT/JP2022/016285

§ 371 Date: Aug. 16, 2024

(30) Foreign Application Priority Data
Feb. 17, 2022 (JP) 2022-023318

(51) Int. Cl. H05B 6/42; H05B 6/10

(52) U.S. Cl. CPC H05B 6/42; H05B 6/101; H05B 2206/022

(57) ABSTRACT

A heating coil (1) is integrally formed by a modeling method of repeating laying, melting, solidifying, and laminating of a powder containing a conductive material based on three-dimensional data. The heating coil includes a pair of plate-shaped grounding portions (2a, 2b) for contact with an electrode through which a high-frequency current is flowed, a pair of plate-shaped supporting portions (3a, 3b) disposed to be perpendicular to the respective grounding portions (2a, 2b), and a sequence of circumferential heating unit (4) disposed to connect distal ends of the supporting portions (3a, 3b) to one another. Three sinking portions (slit-like portions 5, 5 . . . ) are formed in an inner peripheral edge of the heating unit (4) so as to lie along a radiation direction from a center of a heating unit (4).

### TECHNICAL FIELD

The present invention relates to a heating coil used for a high-frequency heater configured to heat a material to be worked using electromagnetic induction by a high-frequency current.

### BACKGROUND ART

For increasing hardness of a portion close to a surface of a metal material to be worked (workpiece), processing (what is called, a hardening process) in which the surface of the material to be worked is heated to a temperature equal to or more than a transformation point (austenite transformation point) of the metal and then rapidly cooled is performed. As a method for performing the hardening process, a method in which a material to be worked is heated with heat generated by electromagnetic induction by bringing an annular metal member (heating coil) to which a high-frequency current has been flowed close to a surface of the material to be worked using a high-frequency heater is widely employed (Patent Document 1).
Patent Document 1: Japanese Unexamined Patent Application Publication No. 2020-115428

### DISCLOSURE OF THE INVENTION

### Problems to be Solved by the Invention

However, when a hardening process is performed on a material to be worked using an annular metal heating coil as disclosed in Patent Document 1, an applied high-frequency current flows only in a close vicinity of an inner peripheral edge of the annular heating coil, making it difficult to perform the hardening on the material to be worked in a wide range. In addition, the conventional heating coil as disclosed in Patent Document 1 needs to be formed by bonding a plurality of components with silver solder or the like. Therefore, continuous use under a high output condition (under a processing condition of applying a high-frequency power supply of a high voltage) easily causes damage, leading to a situation in which a cooling medium leaks out. Furthermore, since the conventional heating coil as disclosed in Patent Document 1 needs to be formed by brazing a plurality of components, it is difficult to manufacture products having the same characteristics with good reproducibility during manufacturing, and this causes a problem that variation occurs in the quality of a material to be worked to be heated.

It is an object of the present invention to solve the above-described problems of the conventional heating coil for a high-frequency heat treatment, and to provide a heating coil for a high-frequency heater that can efficiently perform hardening on a material to be worked in a wide range, is not easily damaged even when an output of a high-frequency power supply is increased, and can be inexpensively and easily manufactured in the same characteristics with good reproducibility during manufacturing.

### Solutions to the Problems

The invention recited in claim 1 among the present invention is a heating coil used for a high-frequency heater configured to heat a material to be worked using electromagnetic induction by a high-frequency current. The heating coil for a high-frequency heater is integrally formed by a modeling method of repeating laying, melting, solidifying, and laminating of a powder containing a conductive material based on three-dimensional data (hereinafter referred to as a partial welding lamination method of conductive material powder layer), or a modeling method of laminating a melted conductive material based on three-dimensional data (hereinafter referred to as a melt extrusion lamination method of conductive material). The heating coil includes a pair of plate-shaped grounding portions for contact with an electrode through which a high-frequency current is flowed, a pair of plate-shaped supporting portions disposed to be perpendicular to the respective grounding portions, and a sequence of circumferential heating unit disposed to connect distal ends of the supporting portions to one another. At least one or more sinking portions are formed in an inner peripheral edge of the heating unit so as to lie along a radiation direction from a center of a heating unit.

In the invention recited in claim 2, which is the invention recited in claim 1, the sinking portions have a slit-like shape.

In the invention recited in claim 3, which is the invention recited in claim 2, the slit-like sinking portions have a width of 5.0 mm or more.

In the invention recited in claim 4, which is the invention recited in any one of claims 1 to 3, a sequence of cooling medium flow-down path for flowing down a medium for cooling is formed inside the respective grounding portions, the respective supporting portions, and the heating unit.

### Effects of the Invention

In the heating coil for a high-frequency heater (hereinafter simply referred to as a heating coil) according to claim 1, since at least one or more sinking portions are formed in the inner peripheral edge of the sequence of circumferential heating unit so as to lie along the radiation direction from the center of the heating unit, an applied current flows not only in a close vicinity of the inner peripheral edge of the heating unit but also in peripheral areas (outer peripheral edges) of the sinking portions. Accordingly, hardening can be efficiently performed on a material to be worked over a wide range.

In addition, the heating coil according to claim 1 is formed by the partial welding lamination method of conductive material powder layer or the melt extrusion lamination method of conductive material based on three-dimensional data. Accordingly, the heating coil can be inexpensively and considerably easily manufactured even though the sequence of circumferential heating unit has a complicated shape that includes the sinking portions. Moreover, products having the same shape and the same characteristics can be efficiently manufactured with good reproducibility regardless of the skill of manufacturing workers. Furthermore, since the heating coil according to claim 1 is formed by the partial welding lamination method of conductive material powder layer or the melt extrusion lamination method of conductive material based on three-dimensional data, a bonding portion by silver solder, as in a conventional heating coil, is not present. Accordingly, deformation does not occur even when the temperature rises due to continuous use, and heat treatment (hardening treatment) according to specifications can be performed over a long period of time.

In the heating coil according to claim 2, since the sinking portions have a slit-like shape, an applied current diverges into a close vicinity of the inner peripheral edge of the heating unit and the peripheral areas of the slit-like sinking portions in a well-balanced manner. Accordingly, hardening can be performed highly effectively on a material to be worked over a wide range.

In the heating coil according to claim 3, since the width of the slit-like sinking portions is adjusted to be equal to or more than a predetermined width, discharge across the slits does not occur even when a high voltage is applied. Accordingly, hardening can be reliably performed on a material to be worked over a wide range.

In the heating coil according to claim 4, the sequence of cooling medium flow-down path for flowing down a medium for cooling is formed not only inside the sequence of circumferential heating unit but also inside each of the grounding portions and each of the supporting portions, and not only the heating unit but also the grounding portions and the supporting portions are simultaneously cooled during heat treatment of a material to be worked. Accordingly, a portion maintained at a high temperature over a long time is not generated. Therefore, since the situation, such as dielectric breakdown caused by carbonization and/or deterioration of an insulating plate and damage due to stress concentration to a specific part, is less likely to occur, the heating coil according to claim 4 is excellent in durability and can undergo the repeated heat treatment to a material to be worked over a long period of time even under a high output condition.

### BRIEF DESCRIPTION OF THE DRAWINGS

FIG. 1 is an explanatory view (plan view) illustrating a state of a current flowing to a heating unit of a heating coil.

FIG. 2 is a perspective view of the heating coil.

FIG. 3 is a plan view of the heating coil (perspective plan view of cooling medium flow-down paths inside).

FIG. 4 is a right side view of the heating coil (perspective right side view of the cooling medium flow-down paths inside).

FIG. 5 is a vertical cross-sectional view of grounding portions of the heating coil (end view of line A-A in FIG. 3).

FIG. 6 is a plan view of a lower circumferential heating body of the heating unit of the heating coil (cross-sectional view of line B-B in FIG. 4).

FIG. 7 is a vertical cross-sectional view of the lower circumferential heating body of the heating unit of the heating coil (cross-sectional view of line C-C in FIG. 6).

FIG. 8 is an explanatory view illustrating a state of manufacturing the heating coil (FIG. 8(a) is a plan view, and FIG. 8(b) is a vertical cross-sectional view).

FIG. 9 is an explanatory view (right side view of the heating unit) illustrating a use state of the heating coil.

FIG. 10 is an explanatory view (plan view) illustrating modifications of the heating coil.

### DESCRIPTION OF PREFERRED EMBODIMENTS

A heating coil according to the present invention requires to be integrally formed by a modeling method based on three-dimensional data using a three-dimensional printer. As the modeling method, a modeling method of repeating laying, melting, solidifying, and laminating of a powder containing a conductive material based on three-dimensional data (partial welding lamination method of conductive material powder layer), or a modeling method of laminating a melted conductive material based on three-dimensional data (melt extrusion lamination method of conductive material) can be employed. The use of the partial welding lamination method of conductive material powder layer as the heating coil modeling method is preferable because a heating coil having a complicated shape and structure can be easily manufactured.

The conductive material used as a raw material of modeling in the present invention means a material that substantially does not have a magnetic property and has satisfactory conductivity. Examples of the conductive material can include copper, brass, and argentum. Among these conductive materials, use of copper is preferable because it allows a reduction in the cost, such as material cost and ensures inexpensively and easily manufacturing the heating coil by a three-dimensional printer, and it also makes the conductivity extremely satisfactory and improves heat generation efficiency by electromagnetic induction.

When copper is used as the conductive material, pure copper can be used. However, use of an alloy (high copper alloy) in which iron, tin, nickel, titanium, beryllium, zirconium, chrome, silicon, or the like is contained in copper with a lower proportion than copper is preferable because laser absorption is increased to allow accelerating temperature rise. Furthermore, among those copper alloys, use of a copper-chrome alloy in which chrome is contained in copper is more preferable because the strength of the heating coil can be effectively enhanced while the production efficiency with the three-dimensional printer is maintained to be high. Use of an alloy in which chrome and zirconium are contained in copper with predetermined proportions (for example, one (high copper alloy) containing 98.71 mass % to 99.45 mass % copper, 0.50 mass % to 1.00 mass % chrome, and 0.05 mass % to 0.25 mass % zirconium) is especially preferable.

When the partial welding lamination method of conductive material powder layer is used to model the heating coil according to the present invention, the laid raw material of modeling (that is, a powder containing a conductive material) needs to be melted by irradiation with a laser or electron beam. While a semiconductor laser, a carbon dioxide laser, an excimer laser, a YAG laser, a fiber laser, or the like can be appropriately used as the laser at that time, use of the fiber laser (that is, a laser that uses an optical fiber in which a rare earth element, such as Yb, is added as a laser medium) is preferable because a laser light without deviation of optical axis can be obtained at a high output by a small-sized device, and the heating coil with high dimensional accuracy can be considerably efficiently manufactured.

When the partial welding lamination method of conductive material powder layer is used to model the heating coil, the output and the wavelength of the fiber laser are not specifically limited. However, the adjustment of the output within a range of 400 W to 1,000 W and the adjustment of the wavelength within a range of 1,000 nm to 1,100 nm are preferable because efficient modeling in a short time can be performed.

When copper (pure copper) is used as the conductive material, to improve the laser absorbance of copper powder for enhancing the production efficiency of the heating coil, an absorbent containing a mixed powder of graphite and an inorganic oxide, or the like can be added to the copper powder.

The heating coil according to the present invention needs to include a pair of plate-shaped grounding portions for contact with an electrode through which a high-frequency current is flowed, a pair of plate-shaped supporting portions disposed to be perpendicular to the respective grounding portions, and a sequence of circumferential heating unit disposed to connect distal ends of the supporting portions to one another. While the supporting portions are not specifically limited in shape insofar as they are a pair of plate-shaped (or rod-shaped) ones disposed to be perpendicular to the respective grounding portions, those with chamfered corner portions are preferable for avoiding a discharge phenomenon when an electric power is applied.

On the other hand, while the heating unit needs to be formed in a sequence of circumferential shape, the heating unit is not limited to a circular one, and may be one having a non-circular shape (for example, a rectangular ring shape in plan view), one having a shape forming a part of a circular ring (that is, an arc shape), one having a shape forming a part of a rectangular or polygonal ring, or the like. In addition, the heating unit may be, for example, one having a shape coupling a plurality of circular bodies, non-circular bodies (such as rectangular ring-shaped bodies in plan view), arc-shaped bodies, or shape bodies forming a part of a rectangular or polygonal ring, which are disposed one above the other, with one or a plurality of vertical columnar bodies or the like.

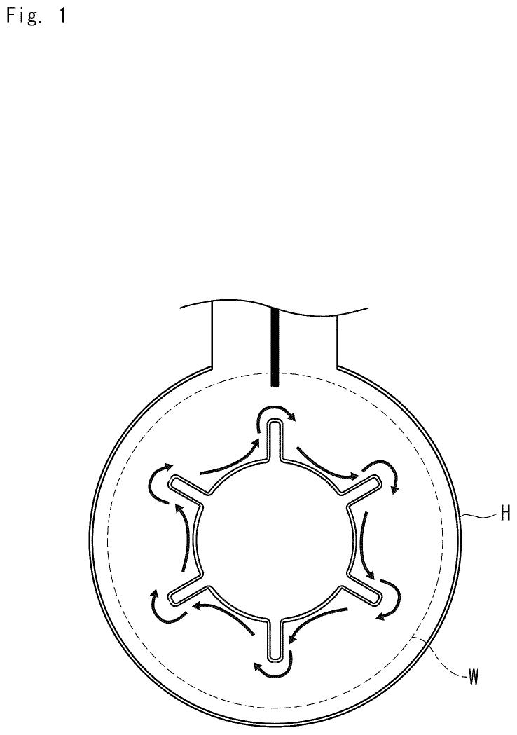

Then, in the heating coil according to the present invention, at least one or more sinking portions need to be formed in an inner peripheral edge of the sequence of circumferential heating unit so as to lie along a radiation direction from the center of the heating unit. Thus, by forming the sinking portions in the inner peripheral edge of the sequence of circumferential heating unit, as illustrated in FIG. 1, when a current is applied, the current flows not only in the close vicinity of the inner peripheral edge of a heating unit H but also in peripheral areas (outer peripheral edges) of slit-like portions (arrows in FIG. 1). Therefore, a hardening process can be efficiently performed on a material to be worked W in a wide range (that is, in a wide width in a radial direction of the material to be worked W).

While the above-described sinking portions are not specifically limited in shape, those having a slit-like shape as illustrated in FIG. 1 are preferable because the applied current diverges into the close vicinity of the inner peripheral edge of the heating unit and the peripheral areas of the slit-like sinking portions in a well-balanced manner, and hardening can be performed highly effectively on a material to be worked over a wide range. Further, when the sinking portions are formed in a slit-like shape, the slit-like portions are also not specifically limited in shape but preferably have a length of 5 mm or more and 50 mm or less. The length of the slit-like portions being less than 5 mm is unpreferable because it is difficult to efficiently perform a hardening process in a wide range. Conversely, the length of the slit-like portions exceeding 50 mm is unpreferable because the current is hard to flow in the close vicinity of the inner peripheral edge of the heating unit, rather lowering the efficiency of the hardening process. The slit-like portions preferably have a width of 5 mm or more and 30 mm or less. The width of the slit-like portions being less than 5 mm is unpreferable because discharge across the slits occurs depending on a voltage applied, narrowing a hardening-processable width. Conversely, the length of the slit-like portions exceeding 30 mm is unpreferable because the current is hard to flow in the close vicinity of the inner peripheral edge of the heating unit, rather lowering the efficiency of the hardening process.

In addition, while the number of the slit-like portions is not specifically limited, two to six slit-like portions are preferably disposed at regular intervals (for each equal angle to the center of the sequence of circumferential heating coil). The number of the slit-like portions being one is unpreferable because a proportion of a current flowing in a part other than the close vicinity of the inner peripheral edge of the heating unit decreases, making it difficult to efficiently perform a hardening process in a wide range. Conversely, the number of the slit-like portions being equal to or more than seven is unpreferable because the current is hard to flow in the close vicinity of the inner peripheral edge of the heating unit, rather lowering the efficiency of the hardening process. As described above, adjusting the number and size (length and width) of the slits can control a heating range.

The sequence of circumferential heating unit preferably includes a cooling medium flow-down path for cooling a material to be worked after heating and cooling the heating unit itself. Furthermore, in the cooling medium flow-down path, a plurality of spray holes for spraying a cooling medium to the material to be worked after heating can be provided. By providing the spray holes, the cooling efficiency of the material to be worked after heating can be further improved.

In addition, in the heating coil according to the present invention, a sequence of cooling medium flow-down path for flowing down the medium for cooling is preferably formed inside each of the supporting portions or inside each of the grounding portions and each of the supporting portions so as to be continuous with the cooling medium flow-down path inside the heating unit. The cooling medium flow-down path may be a single path provided to internally connect the left and right grounding portions, the left and right supporting portions, and the heating unit, or may be two paths provided to internally connect the respective grounding portions, the respective supporting portions, and the heating unit on the left and right sides of the heating coil. In addition, the cooling medium flow-down path formed without a seam or a level difference equal to or more than a predetermined height (1.0 mm or more) on an inner wall, or formed with a bent portion and a coupling portion in smooth curved shapes (curved shapes having a curvature radius of 5 mm or more) is preferable because the flow down aspect of the cooling medium becomes considerably smooth, and the cooling efficiency of the heating unit, the grounding portions, and the supporting portions of the heating unit becomes extremely satisfactory.

Since the heating coil according to the present invention is formed by the partial welding lamination method of conductive material powder layer or the melt extrusion lamination method of conductive material based on three-dimensional data, the heating coil can be considerably easily manufactured even though the sinking portions are formed in the inner peripheral edge of the sequence of circumferential heating unit and the sequence of circumferential heating unit has a complicated shape as described above.

### EXAMPLES

### Example 1

### <Structure of Heating Coil>

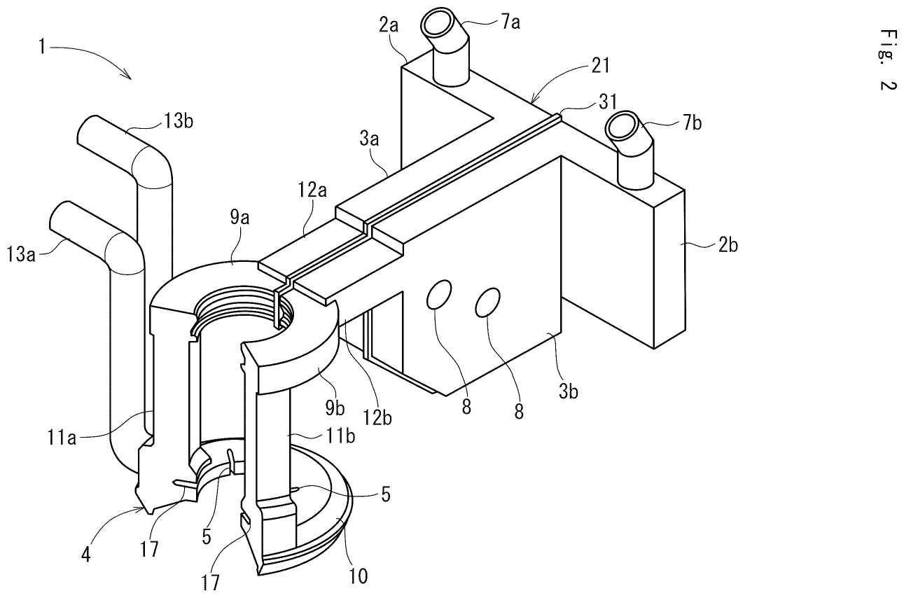

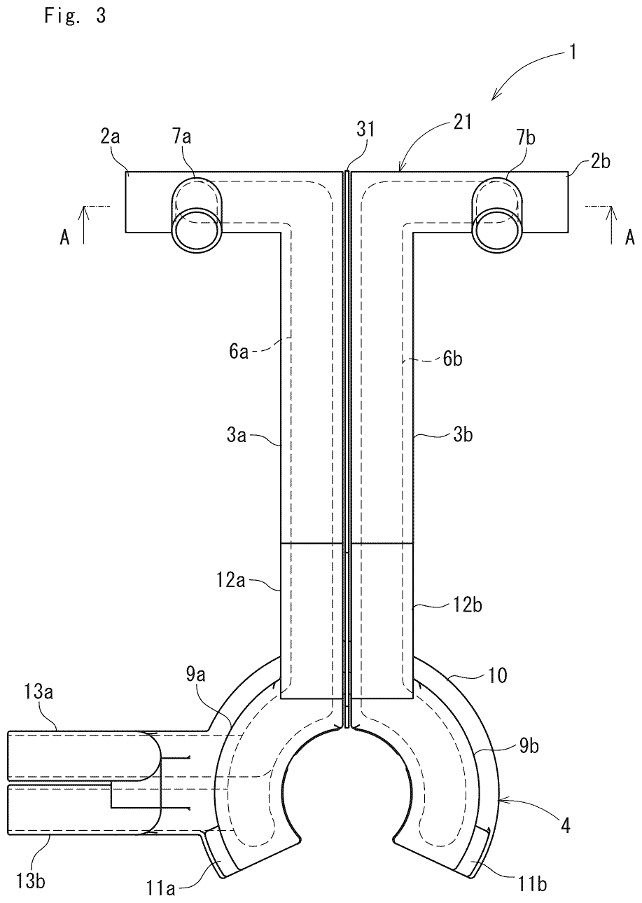

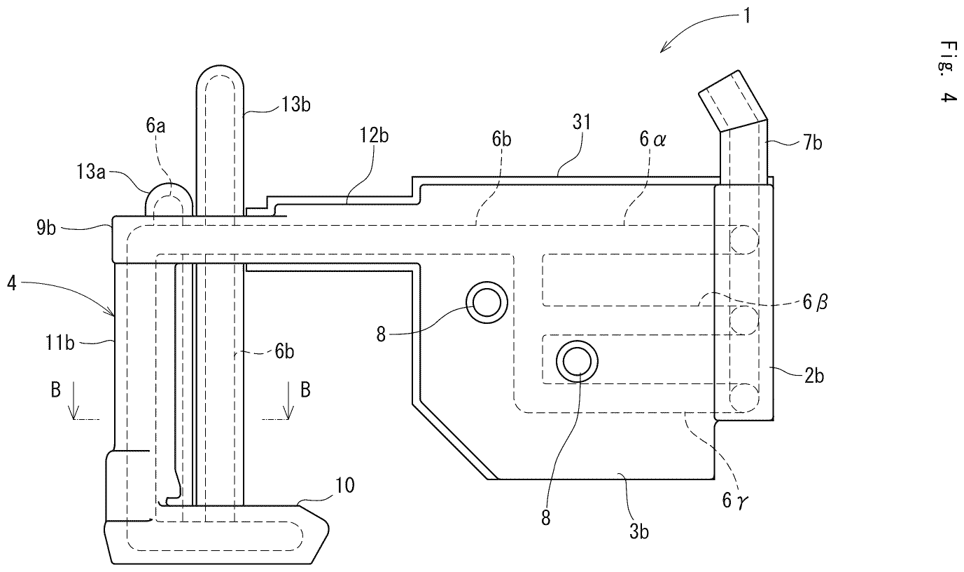

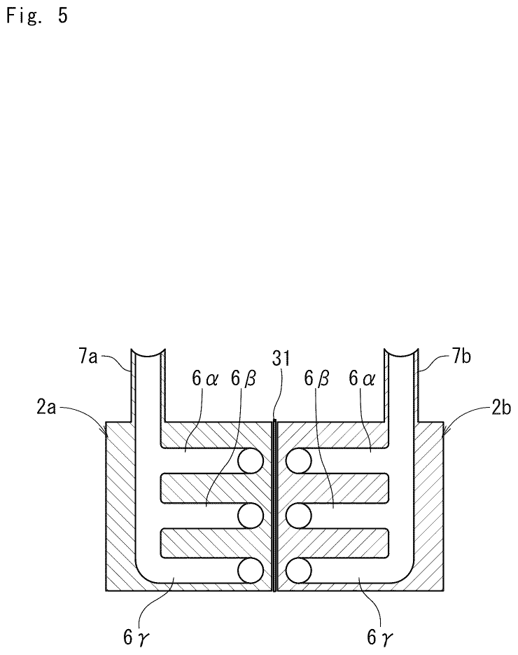

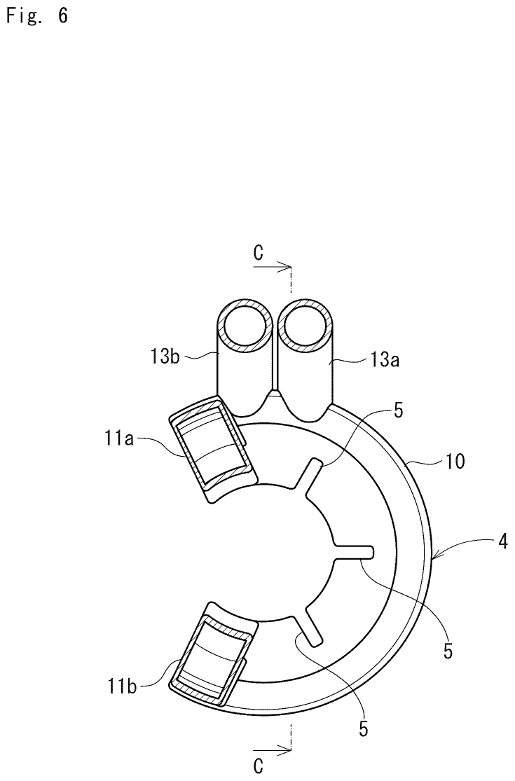

The following describes one embodiment of the heating coil according to the present invention in detail with reference to the drawings. FIG. 2 to FIG. 7 illustrate the heating coil, and a heating coil 1 is constituted of a coil body 21 integrally formed of copper alloy (high copper alloy), a sheet-shaped insulating plate 31 formed of synthetic resin (fluororesin) having an insulating property and heat resistance, and a screw member (not illustrated). Then, the heating coil 1 has a size of longitudinal length (front-rear)×lateral length (width)×height=300 mm×150 mm×100 mm (lengths of the largest portions in longitudinal side, lateral side, and height).

The coil body 21 is formed by a modeling method using a three-dimensional printer described later, and includes grounding portions 2a, 2b for contact with an electrode of a high-frequency power supply, a sequence of circumferential heating unit 4 configured to heat a material to be worked (workpiece) by induction heating, and supporting portions 3a, 3b configured to support the heating unit 4 at positions apart from the grounding portions 2a, 2b, respectively. Since the coil body 21 is formed by the modeling method using a three-dimensional printer, the whole coil body 21 has the same color, and the whole surface has the same roughness (surface roughness).

The respective grounding portions 2a, 2b are formed in a pair of left and right flat rectangular parallelepiped shapes (plate shapes), and disposed to be adjacent left and right at an interval of a predetermined distance (about 2 mm) with one-side side surfaces facing one another. On upper surfaces of the grounding portions 2a, 2b, cylindrical injection pipes 7a, 7b are disposed to project to a side, respectively.

The respective supporting portions 3a, 3b are formed in a pair of left and right flat rectangular parallelepiped shapes (plate shapes), and disposed to be adjacent left and right at an interval of a predetermined distance (about 2 mm) with one-side plate surfaces facing one another. Then, base end edge portions of the supporting portions 3a, 3b are continuous with close vicinities of inner end edges of the left and right grounding portions 2a, 2b, respectively, and plate surfaces of the supporting portions 3a, 3b are perpendicular to plate surfaces of the grounding portions 2a, 2b, respectively.

### <Structure of Heating Unit>

Meanwhile, the heating unit 4 is configured to heat a material to be worked in its inserted state (in a state of being brought closer), and has a shape in which arc-shaped (approximately ⅓ arc-shaped) left and right upper circumferential heating bodies 9a, 9b disposed on an upper side and an arc-shaped (approximately ⅔ arc-shaped) lower circumferential heating body 10 disposed on a lower side are coupled (connected) at close vicinities of respective outer end edges with two vertical columnar heating bodies 11a, 11b. The left and right upper circumferential heating bodies 9a, 9b are disposed to be adjacent left and right at an interval of a predetermined distance (about 2 mm) with inner plate surfaces facing one another, and form one arc shape (approximately ⅔ arc shape). Further, the upper circumferential heating bodies 9a, 9b and the lower circumferential heating body 10 are concentrically disposed in plan view. In addition, the upper circumferential heating bodies 9a, 9b and the lower circumferential heating body 10 are disposed in parallel at an interval of about 20 mm. Then, the upper circumferential heating bodies 9a, 9b are connected to distal ends of the left and right supporting portions 3a, 3b via tubular coupling bodies 12a, 12b, respectively.

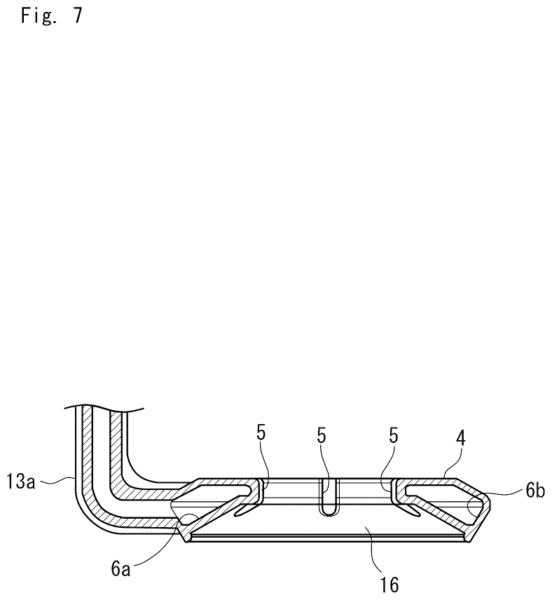

As illustrated in FIG. 7, a lower surface of the lower circumferential heating body 10 inclines downward from the center toward an outside so as to lie along a surface of a material to be worked (forms a tapered surface 16). Then, three slit-like portions 5, 5 . . . that function as sinking portions are formed in an inner peripheral edge of the lower circumferential heating body 10 so as to lie along the radiation direction from the center of the heating unit 4 and cut longitudinally (penetrate) from an upper surface to the lower surface of the lower circumferential heating body 10. Each of the slit-like portions 5, 5 . . . has a length (length along the radiation direction from the center of the heating unit 4) of about 50 mm. Each of the slit-like portions 5, 5 . . . has a width (width in a direction perpendicular to the radiation direction from the center of the heating unit 4) of about 5.0 mm. In addition, slit-like portions 17 with a size of length (length along the radiation direction from the center of the heating unit 4)×height (width in an up-down direction)=about 50 mm×5.0 mm are also formed at lower ends of the left and right columnar heating bodies 11a, 11b (coupling portions with the left and right outer end edges of the lower circumferential heating body 10).

The slit-like portions 17 transect (penetrate) at the lower ends of the respective columnar heating bodies 11a, 11b. Then, lower surfaces of the slit-like portions 17, 17 form the same surfaces as the upper surface of the lower circumferential heating body 10.

In addition, the heating coil 1 has cooling medium flow-down paths 6a, 6b for flowing down a medium (water) for cooling formed inside the heating unit 4 (that is, the upper circumferential heating bodies 9a, 9b, the lower circumferential heating body 10, and the columnar heating bodies 11a, 11b) (that is, the upper circumferential heating bodies 9a, 9b, the lower circumferential heating body 10, and the columnar heating bodies 11a, 11b form a tube shape). Two discharge pipes 13a, 13b for discharging the cooling medium that has flowed down inside the cooling medium flow-down paths 6a, 6b are attached to a left outer side of the heating unit 4.

Furthermore, the heating coil 1 has two left and right sequences of cooling medium flow-down paths 6a, 6b for flowing down the medium for cooling formed inside not only the heating unit 4 but also the coupling bodies 12a, 12b, the grounding portions 2a, 2b, and the supporting portions 3a, 3b such that the cooling medium flow-down paths 6a, 6b are continuous with the inside of the heating unit 4. That is, the left-hand cooling medium flow-down path 6a ranges from the left-hand injection pipe 7a via an inside of the left-hand grounding portion 2a, an inside of the left-hand supporting portion 3a, an inside of the left-hand coupling body 12a, an inside of the left-hand upper circumferential heating body 9a, and an inside of the left rear columnar heating body 11a to the discharge pipe 13a. On the other hand, the right-hand cooling medium flow-down path 6b ranges from the right-hand injection pipe 7b via an inside of the right-hand grounding portion 2b, an inside of the right-hand supporting portion 3b, an inside of the right-hand coupling body 12b, an inside of the right-hand upper circumferential heating body 9b, an inside of the right rear columnar heating body 11b, and an inside of the lower circumferential heating body 10 to the discharge pipe 13b. The left-hand cooling medium flow-down path 6a and the right-hand cooling medium flow-down path 6b reach the inside of the heating unit 4 via the left and right coupling bodies 12a, 12b after branching into three paths (6a, 60, 6y) in the insides of the respective left and right grounding portions 2a, 2b once and having the three paths (6a, 60, 6y) separately introduced into the insides of the respective left and right supporting portions 3a, 3b and then combined into one path inside each of the supporting portions 3a, 3b.

Since the heating coil 1 is integrally formed by a three-dimensional printer, in the left and right cooling medium flow-down paths 6a, 6b, all bent portions and all coupling portions are formed in smooth curved shapes (curved shapes having a curvature radius of 5 mm or more), and a steeply bent shape is not formed. In addition, in the left and right cooling medium flow-down paths 6a, 6b, a seam or a level difference equal to or more than a predetermined height (1.0 mm) is not formed on an inner wall.

Furthermore, the sheet-shaped insulating plate 31 having a predetermined thickness (about 2.0 mm) is sandwiched between the left and right grounding portions 2a, 2b of the coil body 21, between the left and right supporting portions 3a, 3b, and between left and right base end portions of the heating unit 4. In this state, the left and right supporting portions 3a, 3b, and the insulating plate 31 are screwed together by bolts (both not illustrated) inserted through screw holes 8, 8. These bolts screw the supporting portions 3a, 3b and the insulating plate 31 together via bushes (not illustrated) made of synthetic resin (glass epoxy resin) having an insulating property and heat resistance and are configured to avoid conduction between the supporting portions 3a, 3b via the bolts.

### <Manufacturing Method of Heating Coil>

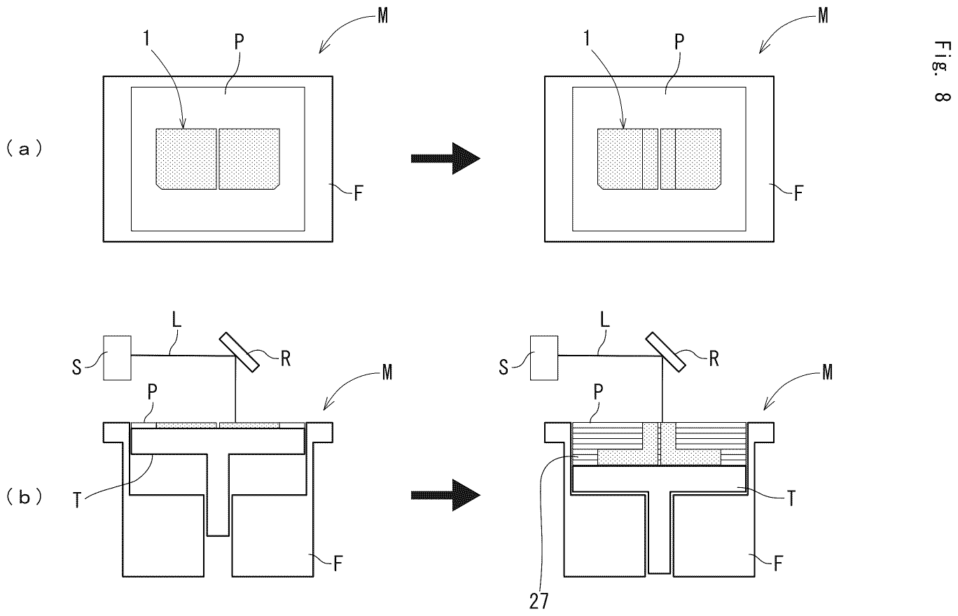

FIG. 8 illustrates a state of forming the heating coil 1 (the coil body 21), and a three-dimensional printer device M for forming the heating coil 1 includes a frame F having a rectangular parallelepiped recessed portion formed in the center, an elevating member disposed to be movable up and down with respect to the frame F, an irradiation means S configured to emit a laser L, a reflection means R configured to reflect the laser, and a driving means and the like (not illustrated) configured to move up and down the elevating member. Then, the elevating member is provided with a table T having approximately the same area as an opening portion of the recessed portion of the frame F.

In manufacturing the heating coil 1 with the three-dimensional printer device M, first, a powder of copper alloy (high copper alloy) is laid with a predetermined thickness (for example, 30 μm) on a surface of the table T of the elevating member at an elevated position (a copper powder is laid by an amount of a gap between the surface of the table T and a surface of an outer frame of the frame F). Then, the copper alloy powder is irradiated with the laser (fiber laser) L of a predetermined output in a predetermined shape to melt, cool, and solidify a part of the copper alloy powder, thereby forming a part of the heating coil 1.

After the formation of the part of the heating coil 1 as described above, the table T of the elevating member is moved down by a predetermined height (for example, 30 μm) by the driving means. Then, at the height position, the operation of “laying the copper alloy powder→irradiating the copper alloy powder with the laser L→cooling and solidifying the melted copper alloy (solidification by coagulation) on the upper side of the part of the previously formed heating coil 1” is repeated. Then, as described above, the operation of “moving down the table T of the elevating member→laying the copper alloy powder→irradiating the copper alloy powder with the laser L→cooling and solidifying the melted copper alloy” is repeated a predetermined number of times (for example, 5,000 times), thereby allowing integrally forming the heating coil 1 made of copper alloy.

### <Use Method of Heating Coil>

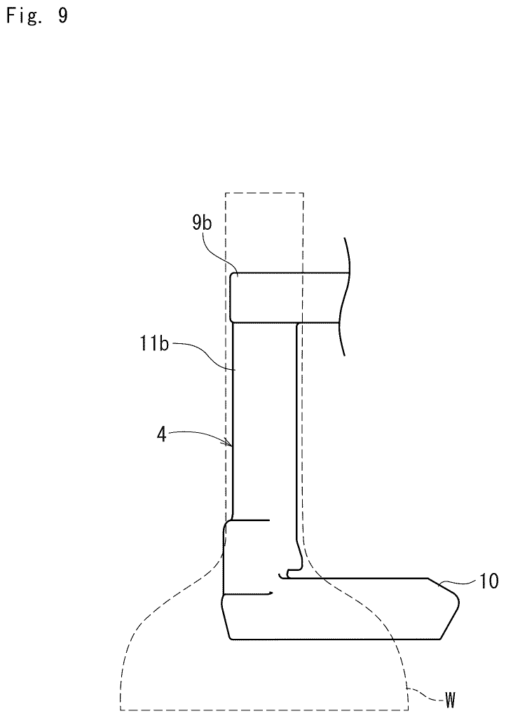

The heating coil 1 configured as described above can heat (harden) the material to be worked W by grounding the left and right grounding portions 2a, 2b to electrodes, turning on an external power supply (high-frequency power supply) via the electrodes, and using an electromagnetic induction phenomenon in a state where the material to be worked W (such as one having a shape in which a small-diameter cylindrical portion projects from the center of an upper side of a large-diameter spherical surface portion) is inserted into the inside of the sequence of circumferential heating unit 4 as illustrated in FIG. 9. Further, by injecting a cooling medium (water) from the left and right injection pipes 7a, 7b into the cooling medium flow-down paths 6a, 6b inside the left and right grounding portions 2a, 2b, allowing the cooling medium to pass through the inside of the heating unit 4, and then discharging it from drainage pipes 13a, 13b, the heating unit 4 and the supporting portions 3a, 3b are efficiently cooled. This can avoid damage and the like due to melting of the insulating plate 31 with high precision.

### <Effect of Heating Coil>

The heating coil 1 includes, as described above, the pair of plate-shaped grounding portions 2a, 2b for contact with the electrodes through which a high-frequency current is flowed, the pair of plate-shaped supporting portions 3a, 3b disposed to be perpendicular to the respective grounding portions 2a, 2b, and the sequence of circumferential heating unit 4 disposed to connect the distal ends of the supporting portions 3a, 3b to one another. At least one or more sinking portions (slit-like portions 5, 5 . . . ) are formed in the inner peripheral edge of the heating unit 4 so as to lie along the radiation direction from the center of the heating unit. Accordingly, with the heating coil 1, an applied current flows not only in the close vicinity of the inner peripheral edge of the heating unit 4 but also in the peripheral areas (outer peripheral edges) of the slit-like portions 5, 5 . . . . Therefore, hardening can be efficiently performed on the material to be worked W over a wide range.

Further, the heating coil 1 is formed by the modeling method (that is, the partial welding lamination method of conductive material powder layer based on the three-dimensional data) using the three-dimensional printer device M. Accordingly, the heating coil 1 can be considerably easily manufactured even though the sequence of circumferential heating unit 4 has a complicated shape. Moreover, products having the same shape and the same characteristics can be efficiently manufactured with good reproducibility regardless of the skill of manufacturing workers. Furthermore, since the heating coil 1 is formed by the modeling method using the three-dimensional printer device M, a bonding portion by silver solder, as in a conventional heating coil, is not present. Accordingly, deformation does not occur even when the temperature rises due to continuous use, and heat treatment (hardening treatment) according to specifications can be performed over a long period of time.

Furthermore, in the heating coil 1, since the sinking portions are those having a slit-like shape (slit-like portions 5, 5 . . . ), an applied current diverges into the close vicinity of the inner peripheral edge of the heating unit 4 and the peripheral areas of the slit-like portions 5, 5 . . . in a well-balanced manner (that is, the applied current does not pass only through the peripheral areas of the slit-like portions 5, 5 . . . ). Accordingly, hardening can be performed highly effectively on the material to be worked W over a wide range.

In addition, in the heating coil 1, since the width of the respective slit-like portions 5, 5 . . . is equal to or more than 5.0 mm, discharge across the respective slit-like portions 5, 5 . . . does not occur even when a high voltage is applied. Accordingly, hardening can be reliably performed on the material to be worked W over a wide range.

Furthermore, in the heating coil 1, as described above, since the sequences of cooling medium flow-down paths 6a, 6b for flowing down a medium for cooling are formed not only inside the heating unit 4 but also inside the respective grounding portions 2a, 2b and the respective supporting portions 3a, 3b, not only the heating unit 4 but also the respective grounding portions 2a, 2b and the respective supporting portions 3a, 3b are simultaneously cooled during heat treatment of the material to be worked W. Accordingly, a situation of being maintained at a high temperature over a long time is not generated. Therefore, since the situation, such as dielectric breakdown caused by carbonization and/or deterioration of the insulating plate 31 and damage due to stress concentration to a specific part, does not occur, the heating coil 1 is excellent in durability and can undergo the repeated heat treatment to the material to be worked W over a long period of time even under a high output condition.

### <Modification of Heating Coil>

The heating coil according to the present invention is not limited to the above-described aspect of the embodiment in any way, and the configuration, such as a material, and shapes and structures of the grounding portions, the supporting portions, the heating unit, the slit-like portions (sinking portions), and the cooling medium flow-down paths, can be appropriately changed as necessary without departing from the gist of the present invention.

For example, the heating unit of the heating coil is not limited to one having a shape in which the arc-shaped left and right upper circumferential heating bodies disposed on the upper side and the arc-shaped lower circumferential heating body disposed on the lower side are coupled at the close vicinities of the respective outer end edges with the two vertical columnar heating bodies as in the above-described embodiment. The heating unit can be changed to one having a simple circular shape, one having a rectangular circumferential shape in plan view, one formed by horizontally arranging divided circular bodies or circumferential bodies one above the other and coupling them with a vertical columnar body (columnar body extending in the up-down direction), or the like.

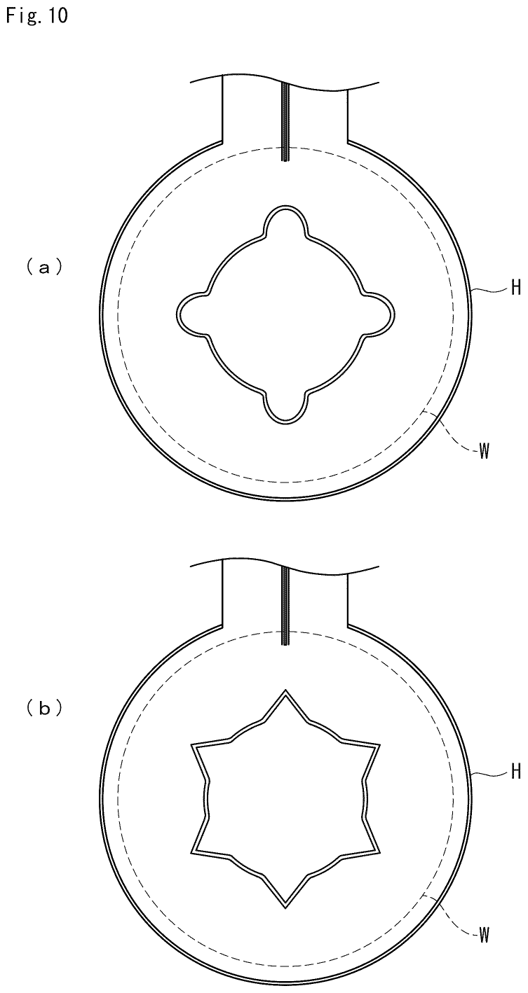

Further, the sinking portions disposed in the heating unit are not limited to those having a slit-like shape as in the above-described embodiment but can be changed to those having an approximately semi-cylindrical shape as illustrated in FIG. 10(a), those having a prismatic shape (such as a triangular prism and a quadrangular prism) as illustrated in FIG. 10(b), or the like.

Furthermore, the heating unit is not limited to one including a single cooling medium flow-down path inside the heating unit as in the above-described embodiment but may be one including a first cooling medium flow-down path for cooling a material to be worked after heating and a second cooling medium flow-down path for cooling the heating unit itself after heating separately. When the configuration is employed, cooling of the material to be worked after heating and cooling of the heating unit itself can be performed more efficiently. In addition, the cooling medium flow-down path is not limited to one branching into three paths inside the grounding portions and the supporting portions as in the above-described embodiment but can be changed to one that does not branch, one branching into two paths or four or more paths inside the grounding portions and the supporting portions, one branching into a plurality of paths inside only any of the grounding portions or the supporting portions, or the like.

Further, the heating coil according to the present invention is not limited to one in which the cooling medium flow-down path has a simple straight or curved shape as in the above-described embodiment but can be changed to one having a shape in which the cooling medium flow-down path is zigzag bent (tortuous) or the like. When the configuration is employed, cooling of the supporting portions and the grounding portions after heating can be performed further efficiently.

In addition, the heating coil according to the present invention is not limited to one in which the insulating plate made of fluororesin (PTFE, PFA, FEP, ETFE, PCTFE, ECTFE, PVDF) insulates between the pair of grounding portions and between the pair of supporting portions as in the above-described embodiment, and can be changed to, for example, one in which the insulating plate made of another synthetic resin having an insulation property and heat resistance, such as polyacetal (POM), polyphenylene sulfide (PPS), and polyetheretherketone (PEEK), insulates between the pair of grounding portions and between the pair of supporting portions.

In addition, the heating coil according to the present invention is not limited to the above-described aspect of the embodiment in any way on the shape and size of the entire heating coil, the shape of the heating unit (the shape of the entire heating unit, the angle of the tapered surface opposed to a material to be worked, the shape and size of the slits, and the like), the shape and size of the grounding portions, the shape and size of the supporting portions, the type (material) and thickness of the sheet-shaped insulating plate, the number of bolts for clamping the insulating plate. However, the heating coil can be appropriately changed according to the shape and the like of a workpiece subjected to a hardening process.

### INDUSTRIAL APPLICABILITY

The heating coil according to the present invention provides the excellent effects as described above, and therefore, can be appropriately used as a member for heating a material to be worked using electromagnetic induction.

### DESCRIPTION OF REFERENCE SIGNS

1 . . . Heating coil
2a, 2b . . . Grounding portion
3a, 3b . . . Supporting portion
4 . . . Heating unit
5 . . . Slit-like portion (sinking portion)
6a, 6b . . . Cooling medium flow-down path
7a, 7b . . . Injection pipe
13a, 13b . . . Drainage pipe

1. A heating coil used for a high-frequency heater configured to heat a material to be worked using electromagnetic induction by a high-frequency current, wherein
the heating coil for a high-frequency heater is integrally formed by a modeling method of repeating laying, melting, solidifying, and laminating of a powder containing a conductive material based on three-dimensional data, or a modeling method of laminating a melted conductive material based on three-dimensional data, and
the heating coil comprises:
a pair of plate-shaped grounding portions for contact with an electrode through which a high-frequency current is flowed;
a pair of plate-shaped supporting portions disposed to be perpendicular to the respective grounding portions; and
a sequence of circumferential heating unit disposed to connect distal ends of the supporting portions to one another, wherein
at least one or more sinking portions are formed in an inner peripheral edge of the heating unit so as to lie along a radiation direction from a center of the heating unit.

2. The heating coil for a high-frequency heater according to claim 1, wherein
the sinking portions have a slit-like shape.

3. The heating coil for a high-frequency heater according to claim 2, wherein
the slit-like sinking portions have a width of 5.0 mm or more.

4. The heating coil for a high-frequency heater according to claim 1, wherein
a sequence of cooling medium flow-down path for flowing down a medium for cooling is formed inside the respective grounding portions, the respective supporting portions, and the heating unit.
